(19) United States
(12) Patent Application Publication
(10) Pub. No.: US 2025/0280859 A1
(43) Pub. Date: Sep. 11, 2025

(54) METHOD OF MAKING A SEAFOOD ANALOGUE

(71) Applicant: SOCIETE DES PRODUITS NESTLE S.A., Vevey (CH)

(72) Inventors: YU-JIE WANG, Lausanne (CH); KATHARINA HINRICHS, Stuttgart (DE); ALICIA GIRARDI, Poliez-Pittet (CH); JOSEPHINE ISABELLE MARIE CHARVE, Lausanne (CH); MARIA ZAHID, St-Legier (CH)

(21) Appl. No.: 18/261,706

(22) PCT Filed: Jan. 21, 2022
(86) PCT No.: PCT/EP2022/051350

§ 371 Date: Jul. 17, 2023

(30) Foreign Application Priority Data
Jan. 22, 2021 (EP) 21153060.5
Jun. 7, 2021 (EP) 21178060.6

(51) Int. Cl. A23L 17/00; A23J 3/14; A23J 3/22; A23L 17/60; A23L 29/212; A23L 29/244; A23L 33/105; A23L 33/185; A23L 33/21; A23P 30/10

(52) U.S. Cl. CPC A23L 17/70; A23J 3/14; A23J 3/225; A23L 17/60; A23L 29/212; A23L 29/244; A23L 33/105; A23L 33/185; A23L 33/21; A23P 30/10

(57) ABSTRACT

The present invention relates to a method of making a seafood analogue, preferably a shrimp analogue, said method comprising preparing a dough by mixing konjac glucomannan and cell wall fiber in water, and adjusting the pH of the dough; preparing gel pieces by heating a portion of the dough to form a gel; cooling the gel and mechanically disrupting to form gel pieces; mixing the gel pieces with the dough to produce a mixture; optionally coloring the mixture; shaping the mixture; heating; and optionally cooling.

### CROSS REFERENCE TO RELATED APPLICATIONS

The present application is a National Stage of International Application No. PCT/EP2022/051350, filed on Jan. 21, 2022, which claims priority to European Patent Application No. 21153060.5, filed on Jan. 22, 2021, and European Patent Application No. 21178060.6, filed on Jun. 7, 2021, the entire contents of which are being incorporated herein by reference.

### INTRODUCTION

Shrimp is one of the most consumed seafoods in the world. However, consumers are increasingly aware of sustainability issues around conventional seafood. Recent years have therefore seen a move towards plant based alternatives.

Hydrocolloids and starches are usually the main ingredients of plant based vegan shrimp on the market. Some vegan shrimps use gelation of alginate in the presence of calcium to create texture. However, these are mostly rubbery and/or are akin to a compact homogenous gel block. They also differ from animal based shrimp which is more fibrous. Moreover, many gums and modified starches are used which are not regarded as clean-label and have poor consumer acceptance.

For the most part, vegan shrimp offerings on the market do not properly mimic the texture and structure of animal-based shrimp.

### SUMMARY OF INVENTION

The present invention relates to a method of making a seafood analogue, preferably a shrimp analogue. The inventors have identified that addition of pea fiber in a konjac glucomannan gel can improve the firmness and reduce the rubbery nature (deformation and resilience), thus making the gel texture closer to animal-based shrimp. The method brings a much improved fibrous structure to the analogue and further reduces the rubbery and compact texture by mixing pre-textured gel pieces in the original gel.

### BRIEF DESCRIPTION OF THE FIGURES

FIG. 1: Qualitative example for a force-distance curve of CUT or PEN test, illustrated with characteristic values that can be identified from curve analysis to characterize shrimp texture.

FIG. 2: Schematic illustration of the force-time plot from a TPA test.

FIG. 3: Dimensions and appearance of real shrimp (a) in comparison to vegan shrimp (b).

FIG. 4: Sensory results-Similarity sensory profiling chart.

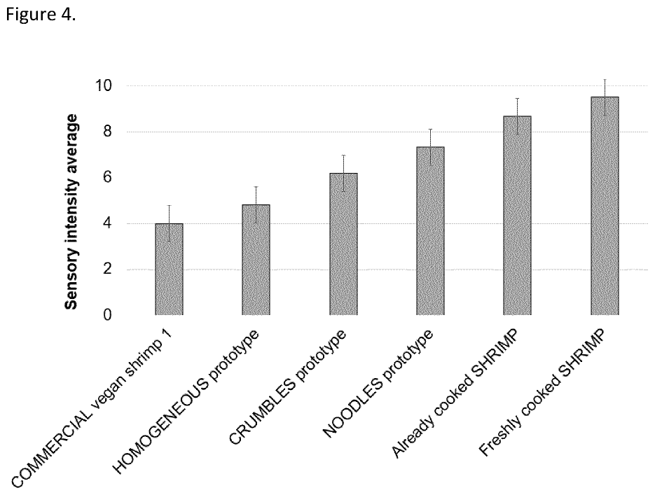

FIG. 5: Sensory results-RATA descriptive sensory profiling chart.

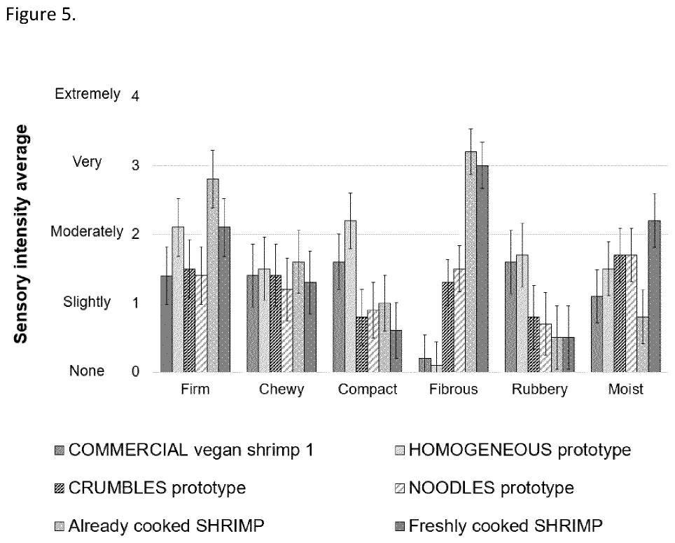

FIG. 6: Exemplary shape of force-distance curve for real shrimp and differently structured vegan shrimps (homogenous, noodles, crumbles).

FIG. 7: Sensory evaluation on the overall seafood odour intensity of samples with konjac or with alginate.

FIG. 8: Relative intensity levels of trimethylamine (expressed in arbitrary units) in konjac-based and alginate-based samples.

FIG. 9: Sensory evaluation on the taste intensity (with nose-clips) of flavored vegan shrimps prepared with different seaweed extracts in the base dough.

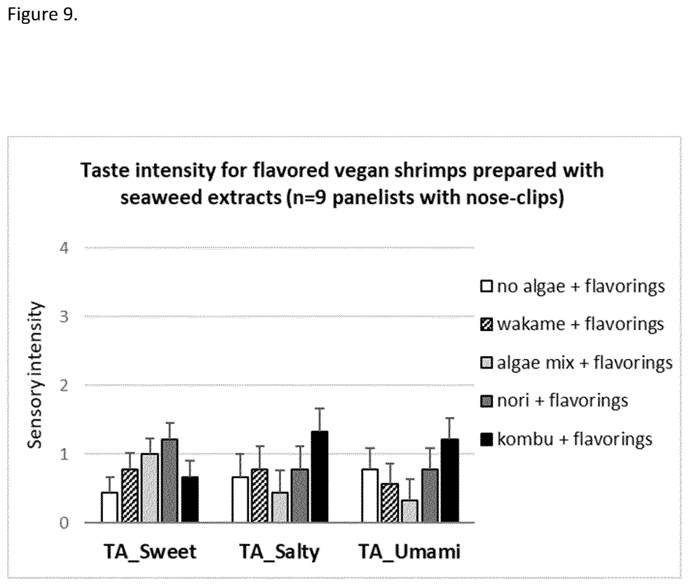

FIG. 10: Sensory evaluation of vegan shrimps prepared with a cold extract of nori seaweed and without extract.

FIG. 11: Sensory evaluation of vegan shrimps prepared with a hot extract of kombu seaweed and without extract.

FIG. 12: Impact of the internal structure of flavored vegan shrimps on the aroma release patterns obtained during their consumption (average of 4 panelists and triplicate samples for the signal of the 6-methyl-5-hepten-2-one).

### EMBODIMENTS OF THE INVENTION

The invention relates in general to a method of making a seafood analogue. The seafood analogue can be a shrimp, crab, squid, or scallop analogue. Preferably, the invention relates to a method of making a shrimp analogue.

In particular, the method of making a seafood analogue comprises
a. Preparing a dough by mixing konjac glucomannan and cell wall fiber;
b. Preparing gel pieces by heating a dough prepared according to step a) until it forms a gel; and mechanically disrupting to form gel pieces;
c. Mixing the gel pieces with the dough to produce a mixture;
d. Shaping the mixture; and
e. Heating the mixture.

Preferably, the invention relates to a method of making a shrimp analogue.

In one embodiment, the konjac glucomannan is de-acetylated prior to mixing with cell wall fiber to prepare the dough. This has the advantage of avoiding high pH usage during the process.

More specifically, the method of making a seafood analogue comprises
a. Preparing a dough by mixing konjac glucomannan and cell wall fiber in water; and adjusting the pH of the dough;
b. Preparing gel pieces by heating a dough prepared according to step a) until it forms a gel; cooling the gel and mechanically disrupting to form gel pieces;
c. Mixing the gel pieces with the dough to produce a mixture;
d. Shaping the mixture;
e. Heating the mixture; and
f. Optionally cooling the mixture.

More specifically, the method of making a seafood analogue comprises
a. Preparing a dough by
   i. Mixing konjac glucomannan, cell wall fiber, and optionally seaweed, in water;
   ii. Adjusting the pH of the dough;
b. Preparing gel pieces by
   i. Dividing the dough from step a) into portions and heating one portion to form a gel; or preparing a dough according to step a) and heating it to form a gel;
   ii. Cooling the gel and mechanically disrupting to form gel pieces;
c. Mixing the gel pieces with the dough prepared in step a) or a portion of dough from step b i.) to produce a mixture;
d. Optionally adding a coloring agent;
e. Shaping the mixture;
f. Heating the mixture; and
g. Optionally cooling the mixture.

More specifically, the method of making a seafood analogue comprises
a. Preparing a dough by
   i. mixing konjac glucomannan, cell wall fiber, and optionally seaweed, in water, wherein the seaweed is whole seaweed or seaweed water extract, for example hot Kombu or cold nori seaweed water extract.;
   ii. Adjusting the pH of the dough by adding alkaline solution while mixing;
b. Preparing gel pieces by
   i. Dividing the dough from step a) into portions and heating one portion to a temperature of between 80° C. to 100° C. to form a gel; or preparing a dough according to step a) and heating it to a temperature of between 80° C. to 100° C. to form a gel;
   ii. Cooling the gel and mechanically disrupting to form gel pieces;
c. Mixing the gel pieces with the dough prepared in step a) or a portion of dough from step b i.) to produce a mixture;
d. Optionally, mixing a coloring agent with a dough prepared according step a) or a portion of dough from step b i.) to produce a colored mixture, and adding the colored mixture to the inside of a mold, for example by brushing;
e. Shaping the mixture from step c) and optionally the colored mixture from step d) in a mold;
f. Heating; and
g. optionally applying a coloring agent, for example by spraying; and
h. Optionally cooling.

Cell wall fiber is added in step a) in order to improve the texture, firmness and reduce the rubbery property of the matrix. Typically, the cell wall fiber has less than 40 wt % cellulose, preferably less than 30 wt % cellulose. The cell wall fiber may be a citrus fiber, wherein the soluble fraction of the citrus fiber is less than 30%. Preferably, the cell wall fiber is pea cell wall fiber, preferably pea inner cell wall fiber.

It has been found that enough cell wall fiber needs to be added in step a) in order to improve the texture but not so much that it breaks the gel and impairs whiteness. Preferably, the cell wall fiber is present at a concentration of between 1 to 10 wt % in the dough, preferably between 3 to 9 wt % in the dough, preferably about 6 wt % in the dough.

Other ingredients including fish flavor are added in step a) in order to provide the taste of the seafood analogue, as well as to maintain the white color of the body part of the seafood analogue. Preferably, plant based natural flavor is added. Preferably, salt is also mixed. Preferably, sugar is also mixed. Preferably, an insoluble mineral salt, for example calcium carbonate (CaCO₃) is also mixed.

Addition of a protein source in step a) has been found to increase the textural stability during storage at cold or freezing temperatures. Preferably, 3 to 10 wt % of a protein source, for example soy protein, for example 3 to 10 wt % soy protein, preferably 5 wt % soy protein is mixed.

Between 1 to 6 wt % starch source, or between 3 to 6 wt % starch source, for example about 4.5 wt % starch source, preferably pea starch, may also be mixed.

In one embodiment, between 3 to 6 wt %, for example about 4.5 wt %, pea starch and between 2 to 5 wt %, for example about 2 wt %, tapioca starch may also be mixed.

Konjac glucomannan has a high molecular weight and needs proper hydration to fully open the structure. Preferably, mixing in steps a i.) and/or a ii.) occurs until at least a constant viscosity is achieved, preferably for at least 30 min, preferably about 40 min.

Preferably, up to 3 wt % konjac glucomannan is mixed, more preferably 0.5 to 2.5 wt %.

In one embodiment, about 1 wt % konjac glucomannan is mixed. In one embodiment, about 1.8 wt % konjac glucomannan is mixed.

The konjac glucomannan may be in the form of a flour comprising at least 50% konjac glucomannan. For example, if the flour comprises 50% konjac glucomannan, then 6 wt % of said flour is mixed.

Deacetylation of konjac glucomannan occurs at high pH, which is needed for gelation. Preferably, the pH is adjusted to 9.5 or above by the addition of alkaline solution, for example Na₂CO₃ solution.

Deacetylated konjac glucomannan will form a heat irreversible gel while heating. Preferably, the dough in step b i) is heated to form a gel, preferably at a temperature of about 90° C., preferably for at least 15 min. It has been found that when the gel from step b i) is disrupted into small pieces, it mimics the fibrous structure in animal shrimp and improves the mouthfeel. Preferably, mechanically disrupting means grinding or slicing or extruding or cutting.

The gel pieces should be able to be perceived whilst eating. Preferably, the gel pieces have an average diameter over their shortest cross section of between 0.1 mm to 5 mm, and an average length over their longest cross-section of between from 0.5 cm to 5 cm. Preferably, the gel pieces have an average diameter over their shortest cross section of between 0.5 mm to 2 mm, and an average length over their longest cross-section of between from 2 cm to 4 cm. Such dimensions are typical of noodle or noodle-like structures.

Gel pieces have a different texture and structure than the dough with which they are mixed. This has been found to improve the perception of fibrosity and firmness of the seafood analogue. Preferably, water is released from the gel pieces. Preferably, the gel pieces are frozen and thawed to release water. This has been found to produce a favorable structure and texture Preferably, between 10-60% water is released, more preferably 30 to 40% water is released, before mixing with the dough.

A large amount of the gel pieces are added in the final mixture with the dough to enhance the perceived gel structure and fibrosity of the seafood analogue. Preferably, the gel pieces are mixed with the dough in a weight ratio of between 0.5:1 to 2:1 to produce a mixture. Preferably, the weight ratio is between 0.8:1 to 1.3:1, preferably about 1:1 gel pieces to dough.

Preferably, the coloring agent is a plant-based orange color, for example a natural plant-based orange color such as carrot and paprika concentrate.

Preferably, the mold comprising the shaped mixture is sealed with a vacuum, and heated, preferably to about 90° C., preferably for about 20 min, preferably by cooking with boiling water, steam, or in an air oven.

In one embodiment, the seafood analogue is frozen and then thawed.

The freezing step can be at a temperature of about −20° C. for at least 90 minutes.

The thawing step can be for at least 5 hours, for example at about 4° C.

The invention further relates to a seafood analogue, preferably a shrimp analogue, made by a method according to the invention.

The invention further relates to a seafood analogue, preferably a shrimp analogue, comprising konjac glucomannan and cell wall fiber.

The seafood analogue comprises gel pieces bound in a continuous matrix.

Typically, the cell wall fiber has less than 40 wt % cellulose. The cell wall fiber may be a citrus fiber, wherein the soluble fraction of the citrus fiber is less than 30%. Preferably, the fiber is pea cell wall fiber, preferably pea inner cell wall fiber.

Preferably, the seafood analogue comprises cell wall fiber at a concentration of between 1 to 10 wt %, preferably between 3 to 6 wt %, or 4 to 6 wt %.

Preferably, the seafood analogue comprises flavor, salt, sugar, and/or an insoluble mineral salt, for example calcium carbonate.

Preferably, the seafood analogue comprises a protein source, for example soy protein, for example 3 to 10 wt % soy protein, preferably 5 wt % soy protein.

Preferably, the seafood analogue comprises a starch source, for example between 1 to 6 wt % starch source, or between 3 to 6 wt % starch source, for example about 4.5 wt % starch source, preferably pea starch.

In one embodiment, the seafood analogue comprises between 3 to 6 wt %, for example about 4.5 wt %, pea starch and between 2 to 5 wt %, for example about 2 wt %, tapioca starch.

The seafood analogue comprises gel pieces having an average diameter over their shortest cross section of between 0.05 mm to 5 mm, and an average length over their longest cross-section ranging from 0.5 cm to 5 cm.

Preferably, the gel pieces are present at a final concentration in the seafood analogue of between 50 to 60 wt %.

Preferably, the seafood analogue comprises a coloring agent, for example a plant-based orange color, for example a natural plant-based orange color such as carrot and paprika concentrate.

Preferably, the seafood analogue is a shrimp analogue.

The invention further relates to a food product comprising the shrimp analogue according to the invention.

The food product may be, for example, a cocktail shrimp, a pasta, a pizza, a salad, a sandwich, a breaded, or a deep fried shrimp. Preferably, the food product is a vegan food product.

The invention further relates to the use of konjac glucomannan and cell wall fiber to produce a seafood analogue, wherein said fiber is a cell wall fiber.

The cell wall fiber has less than 40 wt % cellulose. The cell wall fiber may be a citrus fiber, wherein the soluble fraction of the citrus fiber is less than 30%.

Preferably, the cell wall fiber is pea cell wall fiber, preferably pea inner cell wall fiber.

Preferably, the cell wall fiber is present at a concentration of between 1 to 10 wt % in the dough, preferably 3 to 5 wt % in the dough, preferably about 6 wt % in the dough.

Preferably, natural flavor, salt, sugar, and/or an insoluble mineral salt, for example calcium carbonate (CaCO₃) are also used.

Preferably, a protein source, for example soy protein, for example 3 to 10 wt % soy protein, preferably 5 wt % soy protein is also used.

Preferably, konjac glucomannan, cell wall fiber and water are mixed until at least a constant viscosity is achieved, preferably for at least 30 min, preferably about 40 min.

Preferably, pH is adjusted to 9.5 or above by the addition of alkaline solution, for example Na₂CO₃ solution.

Preferably, the seafood analogue comprises gel pieces having an average diameter over their shortest cross section of between 0.1 mm to 5 mm, and an average length over their longest cross-section ranging from 0.5 cm to 5 cm.

Preferably, water is released from the gel pieces. Preferably, the gel pieces are frozen and thawed to release water. This produces a favorable structure and texture. Preferably, between 10-60% water is released, more preferably 30 to 40% water is released, before mixing with the dough.

Preferably, the seafood analogue comprises a coloring agent, for example a plant-based orange color, for example a natural plant-based orange color such as carrot and paprika concentrate.

Preferably, the seafood analogue is frozen and then thawed.

### Definitions

As used herein, the singular forms “a,” “an” and “the” include plural referents unless the context clearly dictates otherwise.

The words “comprise,” “comprises” and “comprising” are to be interpreted inclusively rather than exclusively. Likewise, the terms “include,” “including” and “or” should all be construed to be inclusive, unless such a construction is clearly prohibited from the context.

The compositions disclosed herein may lack any element that is not specifically disclosed. Thus, a disclosure of an embodiment using the term “comprising” includes a disclosure of embodiments “consisting essentially of and “consisting of the components identified. Similarly, the methods disclosed herein may lack any step that is not specifically disclosed herein. Thus, a disclosure of an embodiment using the term “comprising” includes a disclosure of embodiments “consisting essentially of” and “consisting of” the steps identified.

The term “and/or” used in the context of “X and/or Y” should be interpreted as “X,” or “Y,” or “X and Y.” Where used herein, the terms “example” and “such as,” particularly when followed by a listing of terms, are merely exemplary and illustrative and should not be deemed to be exclusive or comprehensive. Any embodiment disclosed herein can be combined with any other embodiment disclosed herein unless explicitly stated otherwise.

As used herein, “about” and “approximately” are understood to refer to numbers in a range of numerals, for example the range of −10% to +10% of the referenced number, preferably within −5% to +5% of the referenced number, more preferably within −1% to +1% of the referenced number, most preferably within −0.1% to +0.1% of the referenced number.

A vegan product is defined as being devoid of animal products, for example devoid of dairy products and meat products. A vegan shrimp analogue product of the invention has the look, taste, and texture which is close to real shrimp.

The invention will now be illustrated by way of examples, which should in no way be thought to limit the scope of the invention as herein described.

### EXAMPLES

### Example 1

### Ingredient Source and Fiber Composition

Konjac glucomannan (KGM) was purchased from Hubei Yizhi Konjac Biotechnology Co, Ltd., Hubei, China). Pea Fiber Vitacel EF 100 was purchased from J. Rettenmaier & Söhne GmbH & Co. KG, Rosenberg, Germany. Pea Fiber Swelite was purchased from Cosucra Groupe Warcoing S.A., Warcoing, Belgium. Oat Fiber_VITACEL was purchased from J. Rettenmaier & Söhne GmbH & Co. KG, Rosenberg, Germany. Carrot fiber KaroPRO-1-18 was purchased from Food Solutions Team GmbH, Hettlingen, Germany. Coconut fibre Organic coconut flour was purchased from Now Real Food, Bloomingdale, IL, USA. Citrus Fiber AQ Plus was purchased from Herbafood Ingredients GmbH, Werder (Havel), Germany. Soy protein isolate SUPRO 548 IP was purchased from DuPont Nutrition Biosciences ApS, Braband, Denmark.

TABLE 1
The chemical composition of pea fibers and oat fiber.

| | Fiber [%] | | | | | | |
|---|---|---|---|---|---|---|---|
| | | | LMW | HMW | Total | Protein | Starch |
| Sample | Insoluble | Soluble | soluble | soluble | dietary fiber | [%] | [%] |
| Pea fiber Vitacel | 62.1 | 4.42 | 2.19 | 2.23 | 66.6 | 6.4 | 15.9 |
| Pea fiber Swelite | 46.3 | 8.5 | 6.72 | 1.78 | 54.8 | 4.0 | 36.5 |
| Oat fiber Vitacel | 96 | <0.1 | | | >96 | | |

TABLE 2
The monosaccharide composition and lignin content of pea fibers and oat fiber.

| | Monosaccharide composition [mol %] | | | | | | | | |
|---|---|---|---|---|---|---|---|---|---|
| | | | | | | | | Uronic | |
| Fiber name | Xy | Ara | Rha | Fuc | Man | Gal | Glc | acid | Lignin [%] |
| Pea fiber Swelite | 23.0 | 0.6 | 0.0 | 0.0 | 3.6 | 3.7 | 59.0 | 10.0 | 0.3 |
| Pea fiber Vitacel | 7.8 | 23.6 | 1.0 | 0.0 | 0.4 | 4.1 | 51.8 | 11.4 | 0.2 |
| Oat fiber Vitacel | 29.0 | 3.6 | 0 | 0 | 0 | 1.5 | 33.5 | 2.0 | >20 |

### Example 2

### Sensory Analytical Method

The panel (10 panelists) received no specific training on the use of the intensity scales and were naive to the product category.

During the evaluation, the panelists were first instructed to evaluate the samples on their similarity with the real (animal-based) shrimp target. The perceived magnitudes were recorded on a visual analog scale varying from 0 to 10.

The next step was to evaluate all the samples a second time on the attributes from the sensory glossary (see Table 2). The perceived magnitudes were recorded on a Rate All That Apply (RATA) discontinuous scale varying from 0 to 4. The samples were presented one at a time to the panelists (1=slight, 2=moderately, 3=very, 4=extremely).

### Example 3

### Tasting Procedure and Sessions

Shrimp analogue (Vegan shrimp) was provided to the panelists as cold or pan fried. Vegan shrimp 1 from a commercial source was breaded as received and the breading was removed by a fast deep frying. This was the most efficient way of removing breading while keep the structure/texture of the inner shrimp body. The inner shrimp was used to compare with the vegan shrimps of the invention.

Samples were tested at room temperature (about 20° C.). In order to avoid a saturation effect, a maximum of 7 products were evaluated for each single session. Between each sample, panelists were provided with freshly opened Acqua Panna water as palate cleaner. Data were collected using SensIT software (EyeQuestion) in individual sensory booths.

An analysis of variance (ANOVA) was performed for each sensory attribute to determine whether there are some significant differences among products (P<0.05). Post-hoc comparisons between individual factor levels were done with Fisher's Least Significant Difference (LSD).

### Example 4

### Texture Analytical Methods

The texture of real and vegan shrimps was characterized by destructive instrumental Texture Analysis (TA) and by instrumental Texture Profile Analysis (TPA). Both were performed by TA-XT2 Texture Analyzer (Stable Micro Systems, Surrey, England) with a 5 kg load cell. The instrument was controlled by a computer using the software EXPONENT Connect Version 7.0.3.0 that allows test setup as well as data analysis via test specific macros analyzing force distance curves (TA) or force time curves (TPA). By touching the sample surface, data recording started for all tests at a trigger force of 0.05 N.

If no temperature was given, the texture measurements were performed at room temperature (20-22° C.) at least as duplicates using ten (vegan) shrimps per replicate. Data is expressed as means #standard deviation.

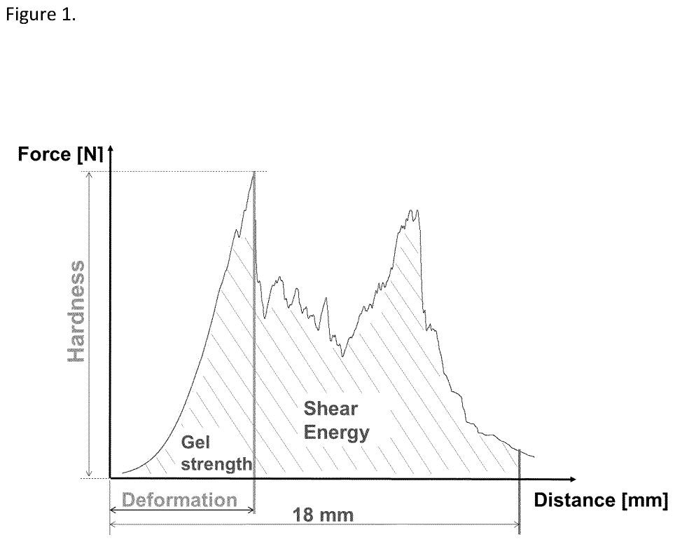

A destructive texture analysis was performed as cutting test (CUT) with a single blade HDP/BS and its corresponding slotted base. The shrimp was placed on its side in the middle of the slotted base, and cut between the first and second segment with a test speed of 1 mm/s for 19 mm. This distance was defined to assure a complete cutting through the shrimp. A force distance-curve was recorded. The maximum cutting force value, corresponding to the sample breakage, was used as an indicator of the hardness of the shrimp. The corresponding distance of the probe at this point of maximum force defines deformation, characterizing the shrimps (elastic) deformability before breakage. The therefore required energy is defined by gel strength. The energy required to cut through the complete shrimp (equal to distance of 18 mm) is defined as shear energy. All values and an example of the curve is given in FIG. 1.

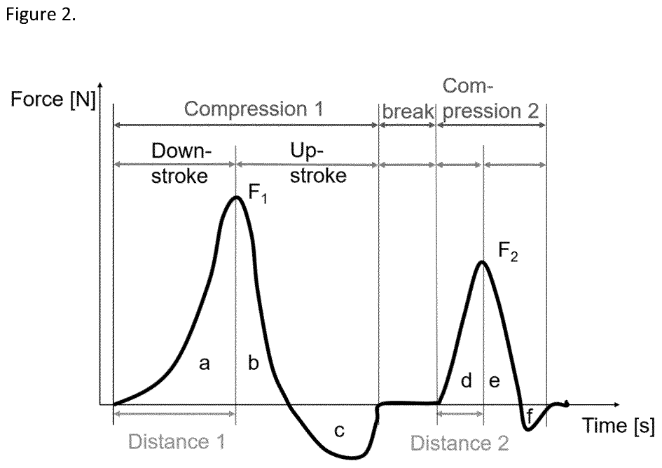

In contrast to texture analysis by a cutting test, where force application on sample happens only once, Texture Profile Analysis (TPA) uses repeated compression cycles to include the level of recovery of the sample. The method, frequently used today for food texture evaluation. Previous studies have defined seven basic textural values (fracturability, firmness, adhesiveness, cohesiveness, gumminess, springiness and chewiness) that can be taken from a recorded force-time curve of TPA measurement. This way, a bridge between the instrumental and sensory evaluation of texture could be served. In the following an example of the curve is given in FIG. 2 and selected TPA parameters used to characterize texture properties of shrimp are explained in more detail.

For TPA, a cylindrical probe (Ø 45 mm) was used to perform two consecutive 30% compression cycles with a pause of 5 s between the two cycles. To apply the TPA on the shrimp, the first segment and the tail (cut between fourth and fifth segment) was removed before placing it on the side in the middle below the probe.

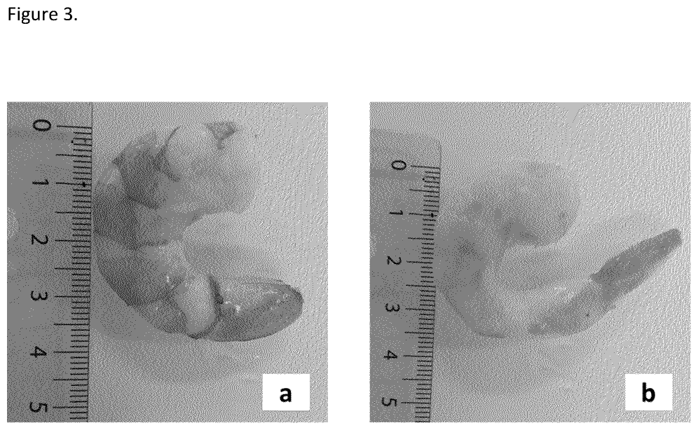

Firmness defines the force applied in the first cycle that is required to compress the sample to 70% of its original height (30% compression). In FIG. 3 it corresponds to F1.

Cohesiveness is the dimensionless ratio of the positive peak area in the second cycle (d+e) and the positive peak area in the first cycle (a+b). It measures how well the sample withstands the second compression relative to resistance under the first compression. If cohesiveness=100%, the sample structure was able to regenerate completely during the pause between the two cycles, meaning that the sample could regain its strength as well as its resistance and withstand the second deformation as well as the first one. In contrast, a cohesiveness <100% expresses a partly irrecoverable deformation in the first cycle, that is followed by lower resistance in the second cycle.

$$Cohesiveness = \frac{( area d + area e )}{( area a + area b )}$$

Gumminess is the product of cohesiveness and hardness. It describes the energy needed to disintegrate a semi-solid food until it can be swallowed.

Gumminess=Cohesiveness·Firmness

Resilience is defined by the area of the first upstroke (area b) relative to the area of the first downstroke (area a). It describes how much the sample retaliates to regain its original shape and size, in other words it is the degree to which the sample returns the probes energy after the downstroke. It expresses the elasticity of the sample including not only the distance, but also force and speed with which the sample fights against the initial deformation. Resilience=100% means that all the work given by the probe into the sample during the downstroke, is returned by the sample during the upstroke. Whereas resilience <100% is equivalent to an incomplete recovery in terms of either thickness (height) or less force or speed in comparison to the compression.

$$Resilience = \frac{area b}{area a}$$

### Example 5

### Recipe for Vegan Shrimp and Preparation Process

TABLE 3
Recipe for vegan shrimp

| Ingredient | Content [%] |
|---|---|
| KGM | 2.3 |
| Pea fiber | 3.5 |
| NaCl | 1.5 |
| Sucrose | 2.0 |
| CaCO₃ | 0.5 |
| Na₂CO₃ | 0.5 |
| Natural flavor | 0.5 |
| Water | 89.2 |
| SUM | 100 |

KGM (moisture content 8.6 wt %), pea inner cell wall fiber (moisture content 7.1 wt %), sucrose, NaCl, CaCO₃ and natural flavor were weighed and mixed homogeneously before hydrating and mixing with water for at least 40 min at room temperature. 0.5% Na₂CO₃ was then suspended in 5% water, and then add to the dough while mixing. The dough was filled into baking molds, sealed and heated to 90° C. for 20 min. The gel was cooled down and ground up with an extruder or slicer into small gel pieces (noodles), with average diameters over their shortest cross section of between 0.5 mm to 2 mm, and average length over their longest cross section of between 2 to 5 cm. The gel pieces were frozen and thawed to release water (35%) and increase the firmness. The gel pieces were mixed with the dough in the ratio of 1:1 to produce a mixture of dough and gel pieces. A few drops of plant-based orange color (carrot & paprika concentrate) were added to a small portion of the dough (e.g. 50 g) to produce an orange dough which is then brushed on the inner surface of the shrimp mold. The mixture of dough and gel pieces was filled in the mold on top of the orange color. The mold was sealed with vacuum before heating to 90° C. for 20 min with steam oven. The shrimp was then cooled down with cold water.

The vegan shrimp with homogenous texture is produced using the dough without gel pieces, and it is used for the investigation of how different fibers and konjac concentration impact the texture.

The vegan shrimp with fibrous structure (gel pieces) is designed for mimicking the structure of the real shrimp. The preformed gels were grinded or sliced into particles or noodle-like bundles and combined with the deacyl-dough before molding.

### Example 6

Recipe for Vegan Shrimp with Fiber Mixture and Preparation Process

TABLE 4
Recipe for vegan shrimp with fiber mixture

| Ingredient | Content [%] |
|---|---|
| KGM | 2.3 |
| Citrus fiber | 1.75 |
| Pea fiber | 3.0 |
| NaCl | 1.5 |
| Sucrose | 2.0 |
| CaCO₃ | 0.5 |
| Na₂CO₃ | 0.5 |
| Natural flavor | 0.45% |
| Water | 88.0 |
| SUM | 100 |

Vegan shrimp with a fiber mixture was prepared following the same preparation process as described in example 5, including citrus fiber into the list of ingredients to be mixed and hydrated at the beginning of the process.

### Example 7

Recipe for Vegan Shrimp with Fiber and Protein and Preparation Process

TABLE 5
Recipe for vegan shrimp with fiber and protein

| Ingredient | Content [%] |
|---|---|
| KGM | 2.3 |
| Soy protein isolate | 5.0 |
| Pea fiber | 3.0 |
| NaCl | 1.5 |
| Sucrose | 2.0 |
| CaCO₃ | 1.0 |
| Na₂CO₃ | 0.5 |
| Water | 84.2 |
| SUM | 100 |

Vegan shrimp with a mixture of fiber and protein was prepared following the same preparation process as described in example 5, including soy protein isolate into the list of ingredients to be mixed and hydrated in the beginning of the process. Therefore, the mixing speed during hydration should be controlled to avoid foaming.

### Example 8

### Vegan Shrimp Appearance

Frozen raw ASC Blacktiger prawns (Paneaeus monodon) from an aquaculture in Vietnam were thawed and cooked in a pan at middle temperature for 3 minutes. The size of the real shrimps corresponded to the size and dimension of the vegan shrimps (FIG. 3).

### Example 9

### Vegan Shrimp Sensory Texture Evaluation

Vegan shrimp with 3.5% pea fiber Vitacel was the closest to real shrimp in terms of texture, comparing to other fibers. Pea fiber swelite showed a similar effect. Oat fiber Vitacel and bamboo fiber Vitacel at 3.5% in recipe gave paper-like rough mouthfeel and bitterness although the appearance was similar to the one with pea fiber.

Vegan shrimp with different structures and one competitor's vegan shrimp (Competitor 1) including konjac in the recipe were compared. Vegan shrimps of the present invention with gel pieces (noodles) were the most similar ones to real shrimp in terms of texture. The homogenous texture and competitor's shrimp were worse.

From the descriptive sensory profiling, it was seen that the 2 real shrimps differed on firmness and moisture. Vegan shrimps provided similar firmness and moisture to the fresh shrimp. Vegan shrimp with fibrous structures had similar rubbery and compact level to real shrimps and homogenous vegan shrimps were too rubbery and compact. The inclusion of structure improved the perceived fibrous texture but still less than the real shrimps.

### Example 10

### Impact of Fiber Content in Vegan Shrimp

In order to understand the contribution of pea fiber (Vitacel EF 100, J. Rettenmaier & Söhne, Germany) to the texture properties of the vegan shrimp, vegan shrimps with different content of pea fiber (0%, 3.5% and 5.0% in recipe) were compared to the real shrimp, using Texture Analyzer.

Pea fiber hardly impacted the hardness (the force to break the sample) of the vegan shrimp (Table 6) Table 1. However, it showed a considerable impact on deformation, firmness and resilience. The deformation and resilience were both reduced by pea fiber addition. The firmness (force required to compress the sample to 30%) considerably increased with the increase of pea fiber content from 2.6 N (0% pea fiber) to 6.0 N (5.0% pea fiber). Pea fiber may act as a filler material, filling the KGM network pores and therefore increases the overall network firmness but not its hardness. In addition, the sensory evaluation also showed that the addition of pea fiber brought the vegan shrimp closer to the texture of real shrimp, giving more firmness and less rubbery. The vegan shrimp texture is closer to shrimp texture with 3.5% pea fiber, while 5% pea fiber drives the texture to more meat-like.

TABLE 6
Textural values determined by TPA and CUT test of vegan
shrimp with varied pea fiber (vitacel) content

| | | Pea fiber concentration | | | | |
|---|---|---|---|---|---|---|
| | | | Real | | | |
| Test | Parameter | [g/100 g] | shrimp | 0.0 | 3.5 | 5.0 |
| CUT | Hardness | [N] | 10.54 ± 6.01 | 7.25 ± 0.73 | 6.72 ± 0.71 | 6.82 ± 0.80 |
| | Deformation | [mm] | 6.23 ± 0.86 | 8.70 ± 0.68 | 7.71 ± 0.44 | 7.28 ± 0.56 |
| | Gel strength | [N · mm] | 24.19 ± 8.17 | 16.66 ± 2.12 | 15.46 ± 2.29 | 16.96 ± 3.67 |
| | Shear Energy | [N · mm] | 99.06 ± 10.82 | 44.95 ± 3.53 | 48.21 ± 3.42 | 53.57 ± 7.98 |
| TPA | Firmness | [N] | 10.29 ± 2.09 | 2.61 ± 0.40 | 5.20 ± 0.65 | 6.06 ± 1.06 |
| | Resilience | [%] | 67.68 ± 4.73 | 76.10 ± 3.07 | 57.54 ± 2.70 | 55.91 ± 3.80 |
| | Cohesiveness | [%] | 85.76 ± 3.56 | 90.02 ± 1.97 | 80.50 ± 2.48 | 80.44 ± 3.13 |
| | Gumminess | [N] | 8.84 ± 1.91 | 2.35 ± 0.32 | 4.24 ± 0.60 | 4.77 ± 0.86 |

The values for the textural parameters are given as means (x̅ ± sd, n = 2).

### Example 11

### Impact of Fiber Type and Composition on Vegan Shrimp Texture

Fibers with different composition were tested to understand which type of fiber may be applicable to support/modulate the vegan shrimp texture. Sensory test (e.g. mouthfeel, color, flavor) and texture analysis were carried out. Pea fiber from hull, pea fiber from endosperm cell wall, oat fiber (straw), bamboo fiber, corn fiber, carrot fiber, and coconut fiber (defatted coconut flour) and citrus fiber were tested.

In general, vegan shrimps with the two different pea fibers showed good texture in both sensory and instrumental analysis, and they are both giving whiteness and neutral taste. Pea fibers are composed of hemicellulose, cellulose and pectin with very low amount of lignin, which were proposed to explain the improved texture and mouthfeel. Starch in pea fiber did not give negative effect.

Oat fiber and bamboo fiber performed similarly to pea fibers in instrumental textual analysis and gave shrimp like white color, however, the mouthfeel was not acceptable at the same content (3.5%). They are bitter, rough and paper-like. This is linked to their composition. Oat fiber (from straw) is mostly cellulose and xylan, and bamboo fiber contained mostly cellulose, both are highly lignified (>20% lignin content).

Corn fiber consists of cellulose, hemicellulose, starch, protein and around 5% lignin, however the native color is usually yellow, which is not suitable for vegan shrimp. Carrot fiber also consist of cellulose (72%), hemicellulose (13) and lignin (15%), it did not give paper-like mouthfeel, but strong carrot taste and beige color. Coconut fiber consists of hemicellulose and cellulose with low amount of lignin, it gives nice whiteness for vegan shrimp, however the mouthfeel was unpleasant being too gritty and had coconut intrinsic taste.

Citrus fiber performed comparable to pea fiber, increasing firmness and hardness slightly. Citrus fiber with neutral taste is a cream-colored powder, maintaining whiteness of the vegan shrimp to an acceptable level. Further a mixture of fibers (1.75% citrus fiber+3% pea fiber) is promising, improving whiteness and textural features.

Therefore, it was concluded that cell wall fiber with white color and neutral taste, containing high content of hemicellulose and pectin and low content of cellulose and lignin would be suitable for texture improvement of vegan shrimp.

TABLE 7
Textural values determined by TPA and CUT test of vegan shrimp with
prepared with different types of filler material (3.5 g/100 g)

| Fiber type | | | Real | Pea fiber | Pea |
|---|---|---|---|---|---|
| Test | Parameter | | shrimp | (vitacel) | swelite |
| CUT | Hardness | [N] | 10.54 ± 6.01 | 6.72 ± 0.71 | 8.24 ± 0.67 |
| | Deformation | [mm] | 6.23 ± 0.86 | 7.71 ± 0.44 | 8.09 ± 0.50 |
| | Gel strength | [N · mm] | 24.19 ± 8.17 | 15.46 ± 2.29 | 19.43 ± 1.13 |
| | Shear Energy | [N · mm] | 99.06 ± 10.82 | 48.21 ± 3.42 | 57.71 ± 4.31 |
| TPA | Firmness | [N] | 10.29 ± 2.09 | 5.20 ± 0.65 | 5.42 ± 0.96 |
| | Resilience | [%] | 67.68 ± 4.73 | 57.54 ± 2.70 | 66.65 ± 5.30 |
| | Cohesiveness | [%] | 85.76 ± 3.56 | 80.50 ± 2.48 | 84.46 ± 4.22 |
| | Gumminess | [N] | 8.84 ± 1.91 | 4.24 ± 0.60 | 4.58 ± 0.91 |

| Fiber type | | | Carrot | Coconut | Oat |
|---|---|---|---|---|---|
| Test | Parameter | | fiber | fiber | fiber |
| CUT | Hardness | [N] | 5.51 ± 0.82 | 8.00 ± 1.01 | 8.62 ± 0.80 |
| | Deformation | [mm] | 7.94 ± 0.49 | 8.69 ± 0.53 | 7.79 ± 0.34 |
| | Gel strength | [N · mm] | 12.23 ± 2.11 | 21.41 ± 3.12 | 19.42 ± 2.27 |
| | Shear Energy | [N · mm] | 41.40 ± 3.11 | 62.65 ± 5.53 | 76.56 ± 4.47 |
| TPA | Firmness | [N] | 3.15 ± 0.61 | 5.17 ± 0.84 | 4.38 ± 0.96 |
| | Resilience | [%] | 63.15 ± 2.20 | 62.70 ± 5.09 | 63.13 ± 1.69 |
| | Cohesiveness | [%] | 85.26 ± 2.00 | 82.13 ± 3.80 | 81.24 ± 1.87 |
| | Gumminess | [N] | 2.79 ± 0.43 | 4.31 ± 0.77 | 3.55 ± 0.74 |

| Fiber type | | | Citrus | Citrus + pea fiber |
|---|---|---|---|---|
| Test | Parameter | | fiber | (vitacell)* |
| CUT | Hardness | [N] | 8.62 ± 1.06 | 7.00 ± 0.68 |
| | Deformation | [mm] | 7.10 ± 0.54 | 6.45 ± 0.67 |
| | Gel strength | [N · mm] | 18.26 ± 2.60 | 13.50 ± 1.51 |
| | Shear Energy | [N · mm] | 65.00 ± 4.21 | 53.60 ± 3.14 |
| TPA | Firmness | [N] | 8.09 ± 0.89 | 7.06 ± 2.57 |
| | Resilience | [%] | 56.97 ± 1.87 | 59.08 ± 3.06 |
| | Cohesiveness | [%] | 81.23 ± 1.36 | 81.76 ± 2.19 |
| | Gumminess | [N] | 6.58 ± 0.75 | 5.75 ± 2.06 |

The values for the textural parameters are given as means (x̅ ± sd, n = 2).
*1.75% citrus fiber + 3% pea fiber (vitacell).

### Example 12

### Impact of Structure on Texture

Real shrimp texture is highly impacted by its microstructure consisting of multiple connected muscle fibers. It is clear, that for the disruption of such a fibrous microstructure of the real shrimp more energy is required compared to the vegan shrimp with a homogenous texture. In order to mimic the fibrous structure as in real shrimp, the crumbles or noodles made from preformed gels were included in the vegan shrimp matrix, which provided the fibrous mouthfeel. The gel pieces (crumbles or noodles) are perceived as fibrous when disintegrated in mouth and when used at high amount.

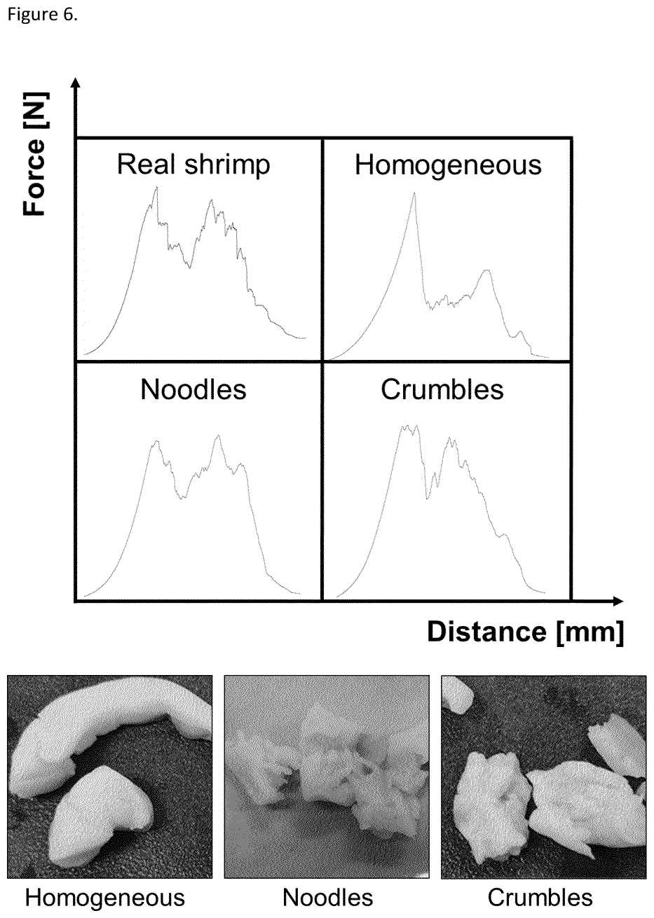

When crumbles or noodles were incorporated in the gel (ratio of gel pieces to dough is 1.3:1), the shape of the curve from cutting test (force-distance) was much closer to the real shrimp, being less smooth and more irregular (two main peaks that are broader and consist of multiple smaller peaks) compared to homogenous gel (two main peaks) (FIG. 6). Incorporation of noodles and crumbles also increased the shear energy required to cut through the sample from 48.21 N·mm (homogenous vegan shrimp) to about 63.51 N·mm (vegan shrimp with noodles) respectively 59.9 N·mm (vegan shrimp with crumbles), getting closer to the real shrimp (FIG. 6). The force required to shear through the vegan shrimp with structures (course of the curve between the two major peaks) was higher and more irregular. The second peak is also significantly lower in the homogenous sample than the first peak, which is less pronounced for the real shrimp and vegan shrimp with structures. Additionally, the noodles and crumbles also increased the resilience (from 57.54% to 64.21% and 67.45%, respectively), bringing it closer to real shrimp.

According to internal technical tasting, the appearance of the shrimps with crumbles or noodles were closer to real shrimp which showed fibrous structure, and they were perceived as fibrous while disintegrating in mouth.

TABLE 8
Textural values determined by TPA and CUT test of real shrimp, vegan shrimp with
homogenous structure and vegan shrimp structured by the addition of differently
shaped gel pieces (noodles, crumbles) to the dough at a weight ratio of 1.3:1.

| | | | | Vegan shrimp | Vegan shrimp | Vegan shrimp |
|---|---|---|---|---|---|---|
| | | | | Structure | | |
| | | | | | Structured | Structured |
| | | | | | Gel pieces shape | |
| Test | Parameter | | Real shrimp | Homogenous | Noodles | Crumbles |
| CUT | Hardness | [N] | 10.54 ± 6.01 | 6.72 ± 0.71 | 6.66 ± 1.61 | 5.97 ± 0.94 |
| | Deformation | [mm] | 6.23 ± 0.86 | 7.71 ± 0.44 | 7.78 ± 0.30 | 7.667 ± 0.42 |
| | Gel strength | [N · mm] | 24.19 ± 8.17 | 15.46 ± 2.29 | 17.44 ± 3.11 | 16.51 ± 3.23 |
| | Shear Energy | [N · mm] | 99.06 ± 10.82 | 48.21 ± 3.42 | 63.51 ± 8.54 | 59.94 ± 16.03 |
| TPA | Firmness | [N] | 10.29 ± 2.09 | 5.20 ± 0.65 | 5.60 ± 1.02 | 6.11 ± 0.93 |
| | Resilience | [%] | 67.68 ± 4.73 | 57.54 ± 2.70 | 64.21 ± 3.60 | 67.45 ± 5.85 |
| | Cohesiveness | [%] | 85.76 ± 3.56 | 80.50 ± 2.48 | 84.07 ± 2.48 | 86.05 ± 3.96 |
| | Gumminess | [N] | 8.84 ± 1.91 | 4.24 ± 0.60 | 4.71 ± 0.92 | 5.28 ± 0.97 |

The values for the textural parameters are given as means (x̅ ± sd, n = 2).

Freezing and subsequent thawing of gel pieces (noodles) led to a significant water release (35-45%) and therefore to a better perception of the vegan shrimps' fibrosity during chewing. The vegan shrimp was firmer and more bites were required before swallowing. This is in accordance to the textural data (Table 9), showing a significant increase of firmness, and shear energy. A ratio of 1 to 1 of gel pieces to dough in the vegan shrimp was closer to the texture of the animal reference than a ratio of 1.3 to 1, especially cohesiveness and resilience was too low for the latter ratio in comparison to the animal reference.

TABLE 9
Textural values determined by TPA and CUT test of vegan shrimp
structured by the addition of freeze-thawed gel pieces (noodles)
at different weight ratios of gel pieces to dough.

| Vegan shrimp structured by freeze-thawed | | | | |
|---|---|---|---|---|
| Ratio: gel pieces:dough | | | Noodles | Noodles |
| Test | Parameter | | 1:1 | 1.3:1 |
| CUT | Shear Energy | [N · mm] | 71.37 ± 8.20 | 164.01 ± 31.67 |
| TPA | Firmness | [N] | 8.10 ± 1.43 | 12.12 ± 1.87 |
| | Resilience | [%] | 61.82 ± 1.93 | 56.02 ± 3.57 |
| | Cohesiveness | [%] | 81.92 ± 0.86 | 78.50 ± 2.82 |
| | Gumminess | [N] | 6.64 ± 1.15 | 9.53 ± 1.90 |

The values for the textural parameters are given as means (x̅ ± sd, n = 2).

Temperature of vegan shrimp has an impact on final texture. When the vegan shrimp of the invention was cooked and consumed at higher temperature, it was harder and closer to animal shrimp (Table 10). The vegan shrimp from commercial producer 1 was rubbery and soft especially at higher temperature (e.g when cooking and consuming as warm).

TABLE 10
Textural values determined by TPA and CUT test of vegan shrimp
(own product, competitor) at two different temperatures.

| | | | Own product | | Commercial vegan shrimp 1 | |
|---|---|---|---|---|---|---|
| | | Temperature | | | | |
| Test | Parameter | [° C.] | 20-25 | 60-65 | 20-25 | 60-65 |
| CUT | Hardness | [N] | 6.72 ± 0.71 | 8.99 ± 1.15 | 6.56 ± 1.21 | 7.11 ± 1.79 |
| | Deformation | [mm] | 7.71 ± 0.44 | 8.12 ± 0.44 | 6.06 ± 0.70 | 7.02 ± 0.71 |
| | Gel strength | [N · mm] | 15.46 ± 2.29 | 22.11 ± 3.32 | 10.88 ± 2.91 | 12.25 ± 4.23 |
| | Shear Energy | [N · mm] | 48.21 ± 3.42 | 58.14 ± 5.57 | 39.72 ± 3.15 | 44.22 ± 9.92 |
| TPA | Firmness | [N] | 5.20 ± 0.65 | 5.67 ± 1.09 | 4.10 ± 0.74 | 1.98 ± 0.59 |
| | Resilience | [%] | 57.54 ± 2.70 | 69.52 ± 3.80 | 83.63 ± 4.59 | 72.66 ± 3.52 |
| | Cohesiveness | [%] | 80.50 ± 2.48 | 83.05 ± 2.95 | 95.09 ± 2.50 | 89.00 ± 2.48 |
| | Gumminess | [N] | 4.24 ± 0.60 | 4.42 ± 1.15 | 3.89 ± 0.66 | 1.75 ± 0.48 |

### Example 13

### Vegan Calamari (Squid) Product

### Recipe:

| Ingredient | Content [%] |
|---|---|
| Natural flavor | 0.5 |
| KGM | 2.3 |
| Pea fiber | 5 |
| NaCl | 1.5 |
| Sucrose | 2.0 |
| CaCO₃ | 0.5 |
| Na₂CO₃ | 0.5 |
| Water | 88.0 |
| SUM | 100.0 |

Calamari has more chewy texture, therefore, the pea fiber was increased to 5%. Process was the same as example 5 with homogenous texture, as the animal squid is not fibrous. The final gel was cut in the ring shape and can be breaded before deep frying.

### Example 14

### Vegan Scallop Product

### Recipe:

| Ingredient | Content [%] |
|---|---|
| Natural flavor | 0.5 |
| KGM | 2.0 |
| Pea fiber | 3.5 |
| NaCl | 1.5 |
| Sucrose | 2.0 |
| CaCO₃ | 0.5 |
| Na₂CO₃ | 0.5 |
| Water | 89.5 |
| SUM | 100.0 |

Lower concentrations of konjac and pea fiber are used to produce softer texture as animal scallop has softer texture. The process is the same as example 5.

Temperature impact of vegan shrimp (3.5% pea fiber, homogenous). The vegan shrimp from commercial producer 1 was rubbery and soft especially at higher temperature (e.g when cooking and consuming as warm).

TABLE 11
Textural values determined by TPA and CUT test of vegan shrimp
(own product, competitor) at two different temperatures.

| | | | Own product | | Commercial vegan shrimp 1 | |
|---|---|---|---|---|---|---|
| | | Temperature | | | | |
| Test | Parameter | [° C.] | 20-25 | 60-65 | 20-25 | 60-65 |
| CUT | Hardness | [N] | 6.72 ± 0.71 | 8.99 ± 1.15 | 6.56 ± 1.21 | 7.11 ± 1.79 |
| | Deformation | [mm] | 7.71 ± 0.44 | 8.12 ± 0.44 | 6.06 ± 0.70 | 7.02 ± 0.71 |
| | Gel strength | [N · mm] | 15.46 ± 2.29 | 22.11 ± 3.32 | 10.88 ± 2.91 | 12.25 ± 4.23 |
| | Shear Energy | [N · mm] | 48.21 ± 3.42 | 58.14 ± 5.57 | 39.72 ± 3.15 | 44.22 ± 9.92 |
| TPA | Firmness | [N] | 5.20 ± 0.65 | 5.67 ± 1.09 | 4.10 ± 0.74 | 1.98 ± 0.59 |
| | Resilience | [%] | 57.54 ± 2.70 | 69.52 ± 3.80 | 83.63 ± 4.59 | 72.66 ± 3.52 |
| | Cohesiveness | [%] | 80.50 ± 2.48 | 83.05 ± 2.95 | 95.09 ± 2.50 | 89.00 ± 2.48 |
| | Gumminess | [N] | 4.24 ± 0.60 | 4.42 ± 1.15 | 3.89 ± 0.66 | 1.75 ± 0.48 |

### Example 15

### Konjac and Seafood Odour

The following samples were produced:
Sample 1: Dough prepared with konjac glucomannan (KGM). The recipe includes 2.3% KGM, 84.7% Vittel water, 1.5% salt, 2% sucrose, 0.5% calcium carbonate.
Sample 2: KGM dough same as Sample 1 with the addition of an alkali solution (0.53% sodium carbonate, 5.3% Vittel water).
Sample 3: KGM dough with alkali solution same as Sample 2 with heat treatment (conventional oven with fan setting at 100° C. for 50 mins; dough core temperature 90° C.).
Sample 4: same as Sample 3 but KGM dough hydration prepared with nori water extract (0.4%). The dough was similarly heat treated as Sample 3.
Sample 5: alginate-based dough with no KGM addition. This was to evaluate the flavor profile when KGM was not added. The recipe includes 3.17% sodium alginate, 5.83% soy protein isolate, 2.5% potato starch, 0.17% sodium citrate, 63.5% deionized water, and 3% calcium lactate encapsulated in coconut oil. The dough was similarly heat treated as Sample 3. Calcium was released while heating which induced alginate gelation.
Sample 6: alginate-based dough same as Sample 5 prepared with nori water extract (0.4%). This was to evaluate whether seafood aroma could be brought from nori seaweed extract. The dough was similarly heat treated as Sample 3.

Nine participants were recruited to smell the samples with and without konjac glucomannan (KGM). The panelists received no specific training on the use of the intensity scales and were naïve to the product category. Samples were identified using a 3-digit random code. The samples were presented in a randomized order.

All samples were put in glass jars with metal lids and kept at 45° C. in an oven for 30 min before given to panelists. Panelists were asked to smell above the samples and score its overall intensity of the perceived seafood odour on a continuous scale from 0 to 10. Seafood odour includes fish, shellfish and marine/sea note (e.g. fresh or cooked fish, mollusks such as mussels and squids, crustaceans such as shrimps and crabs, ocean/beach shores, etc.). Additionally, they were asked to provide comments/descriptions of each sample on the perceived flavor in more details.

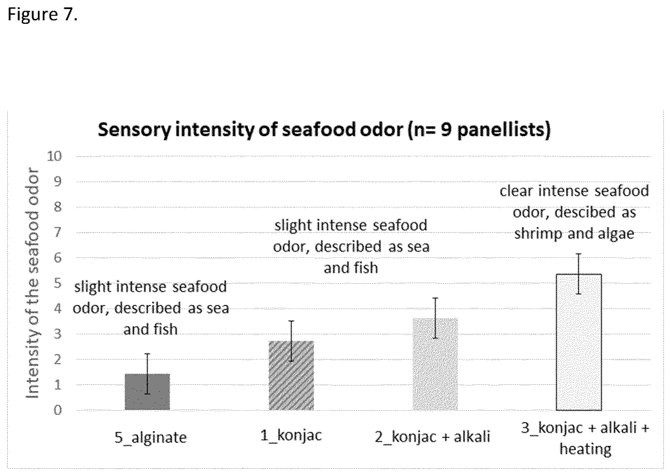

Results are shown in FIG. 7. When konjac was treated with alkali and heating step, it showed a clear intense seafood smell. “konjac+alkali+heating” were significantly more intense than all the other samples on this overall seafood odour. It was described as shrimp and algae (and some other mussel/fish/iode/sulfur notes). “Konjac” and “konjac+alkali” were perceived as slightly intense in seafood smell (described as sea/fish). “Alginate” sample had no to just perceptible seafood odour. Its smell was described as earthy/oxidized/cereal/pasta like smell.

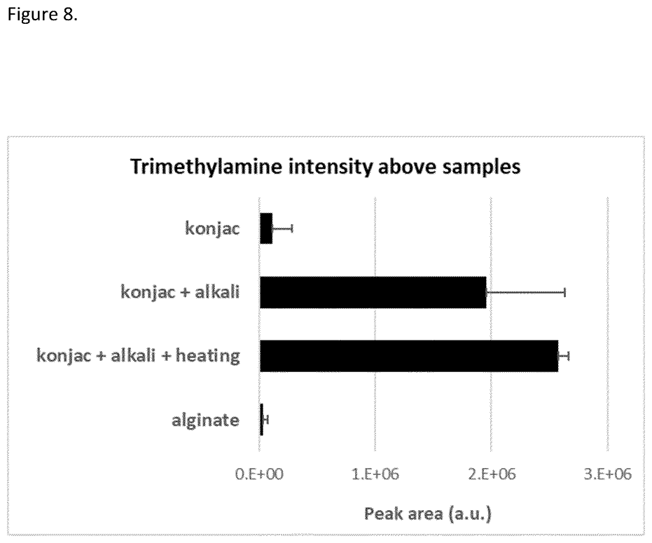

Trimethylamine (TMA) is known for its fish aroma character. The determination of TMA levels in the headspace above samples was achieved by Solid Phase Micro-Extraction (SPME) coupled with gas-chromatography mass spectrometry (GC-MS). A piece of shrimp (ca. 3.5 g) was placed in 10-mL screw caps vials and loaded in the Gerstel autosampler at 8° C. until analysis. The vials were incubated for 10 min at 45° C. and the SPME fiber (PDMS/DVB 65 um, Supelco) was exposed to the headspace for 20 min. The fiber was then desorbed for 15 min in the GC-inlet port (250° C., splitless) equipped with a DB-WAX column (J&W, 30 m, 0.25 mm ID, 25 um thickness). The helium gas flow rate was maintained at 1 mL/min and the oven program was as follows: 40° C. for 2 min, then increased to 230° C. at 6° C./min and held for 5 min before returning to the initial conditions. The mass spectrometer was used in Electron Impact ionization mode (70 ev) using SCAN mode from m/z 29 to 300. For the relative quantification of TMA, the ions 42, 58 and 59 were monitored and the peak area of ion 58 was chosen for the quantification of TMA (peak area in arbitrary units) and used to indicate the intensity of seafood odour. Identification of the TMA was confirmed with injection of an analytical standard and using a mass-spectral library (NIST17). Results are shown in FIG. 8.

TMA levels are almost null in samples made with konjac dough without treatment and made from alginate gel. On the other hand, TMA levels are higher when konjac glucomannan is used with an alkaline solution, and further increased with a heating step.

### Example 16

### Seaweed Extract for Enhanced Flavor

Different edible seaweeds, namely, wakame (Undaria pinnatifida), kombu (Saccharina japonica) and nori (Pyropia yezoensis), were screened for their potential to increase the flavor of the vegan shrimps. The dried seaweeds were shredded into small pieces (<1 cm) and steeped in boiling water for 5 min at 0.1% (w/w), then sieved and the extract was recovered. The seaweed extract was used for rehydration of the konjac glucomannan powder. Next, the vegan shrimps were prepared following the standard procedure as disclosed herein in combination with the addition of natural flavors.

Within the same flavored base, there are differences in the perceived taste intensity depending on the seaweed extract (0.1%) used for preparation:
nori and the commercial algae mix (nori, wakame, sea lettuce, dulse in unknown proportions) are boosting sweetness
kombu is boosting saltiness and trends for increasing umami.
wakame has no impact on taste compared to the shrimps prepared without seaweed extract

### Example 17

### Impact of Extraction Parameters on the Flavor Intensity and Taste of the Unflavored Shrimp Base

The impact of extraction parameters, such as water temperature, steeping time and seaweed content, on the flavor profile of the vegan shrimps prepared with the seaweed extracts was investigated. The differences were examined between hot (80-100° C.) and cold (5-25° C.) extraction, with different steeping times (5 to 30 min) and seaweed content (0.1 to 0.5% w/v).

The dried seaweeds were shredded into small pieces (<1 cm) and extracted with the parameters listed above, then sieved and the extract was recovered. The seaweed extract was used for rehydration of the konjac glucomannan powder. Next, the vegan shrimps were prepared following the standard procedure with no addition of natural flavors. After an initial screening, the following samples were further characterized by sensory analyses:
Sample 1: vegan shrimp prepared with a nori cold extract (0.4% w/v, steeping at 20° C. for 30 min)
Sample 2: vegan shrimp prepared with a nori hot extract (0.4% w/v, steeping at 100° C. for 5 min and cool-off for 30 min before sieving)
Sample 3: vegan shrimp prepared with a kombu hot extract (0.4% w/v, steeping at 100° C. for 5 min and cool-off for 30 min before sieving)

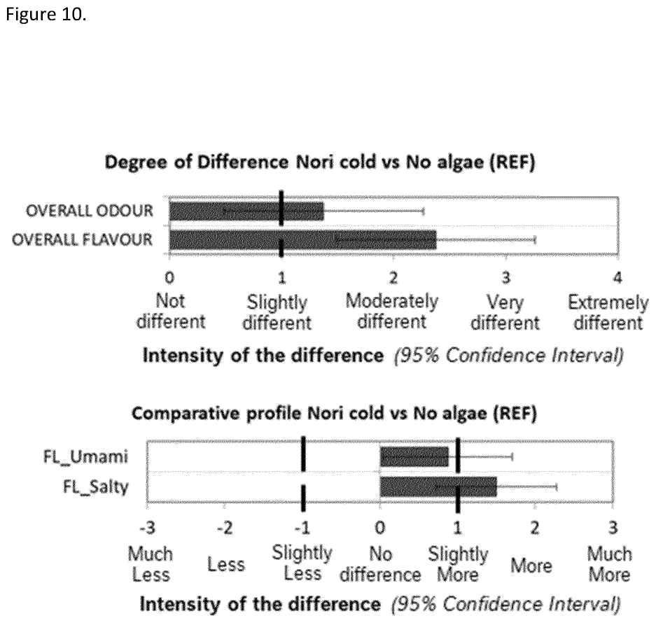

In FIG. 10, the sensory differences between vegan shrimps prepared with a cold extract of nori seaweed and without extract are shown. The top figure shows the overall differences in flavor and the bottom figure shows the magnitude of the difference for specific taste attributes. (n=8 panellists, the red bars indicate a significant difference.)

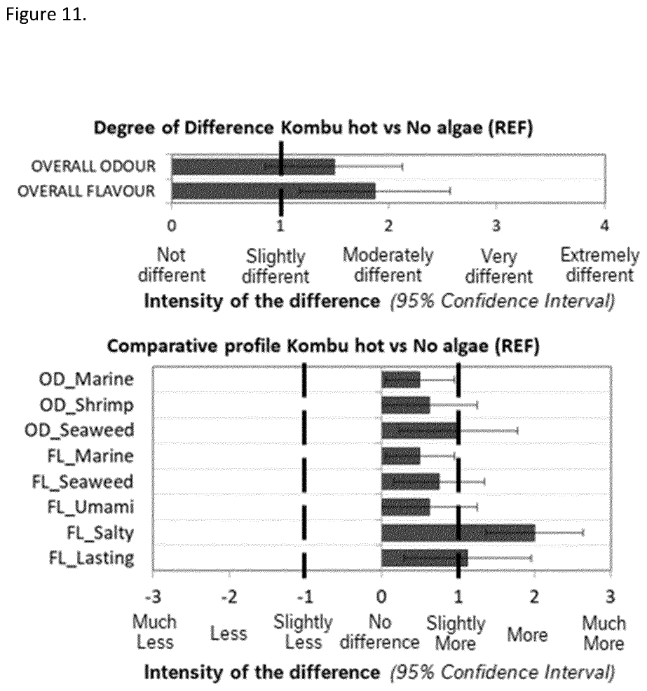

In FIG. 11, the sensory differences between vegan shrimps prepared with a hot extract of kombu seaweed and without extract are shown. The top figure shows the overall differences in flavor and the bottom figure shows the magnitude of the difference for specific odor and taste attributes. (n=8 panellists, the red bars indicate a significant difference.)

Seaweed extracts (0.4%) were used for the preparation of the vegan shrimps (no flavorings added) and compared against vegan shrimps without seaweed extract.

The use of seaweed extracts, preferably nori or kombu, improved the taste intensity and profile of the vegan shrimps. Extraction parameters, such as temperature and steeping time, also impacted the final flavor.
nori cold: a “moderate” flavor difference was perceived it was described as more salty and tended to be slightly more umami than without seaweed extract (FIG. 10);
kombu hot: a “moderate” flavor difference was perceived, it was described as more salty and more flavour lasting, tended to smell slightly more marine, shrimp, seaweed than without seaweed extract (FIG. 11).

### Example 18

### Shrimp Structure and Aroma Release

Three different internal structures for the vegan shrimps were evaluated and their impact on the aroma release during consumption was examined. The following samples were prepared:
Sample 1: continuous and homogenous gel structure
Sample 2: noodle-like structure
Sample 3: crumble-like structure

The current texture was achieved by incorporation of preformed noodles in the dough composed of konjac glucomannan and pea fiber. The noodles are produced by precooking the dough with the same recipe. The noodles are similar to shirataki konjac noodles which are formed by heating the hydrated konjac powder with calcium hydroxide.

Prior to cooking, the base dough was flavored with different aroma compounds found in shrimp flavor which will be used to illustrate the release of the aroma compounds from the matrix.

For each structure evaluated, four trained panelists were asked to place in their mouth a shrimp (˜ 9 g) and start its consumption. The food oral processing of the shrimp was broken down in different phases: breathing to allow for baseline determination, chewing, and finally swallowing the sample. To harmonize the mastication/breathing patterns between individuals, a display on screen was indicating them which step to perform (e.g., inhale, exhale, chew, swallow). The procedure was repeated three times per type of shrimps for each panelist.

Two aroma compounds were selected and monitored to illustrate the aroma release from the shrimp matrix into the oral cavity and then in the nose-space during consumption: dimethyl sulfide and 6-methyl-5-hepten-2-one. The exhaled air coming out of the nostrils was directed towards an insulated transfer line connected to an on-line Proton Transfer Reaction-Mass

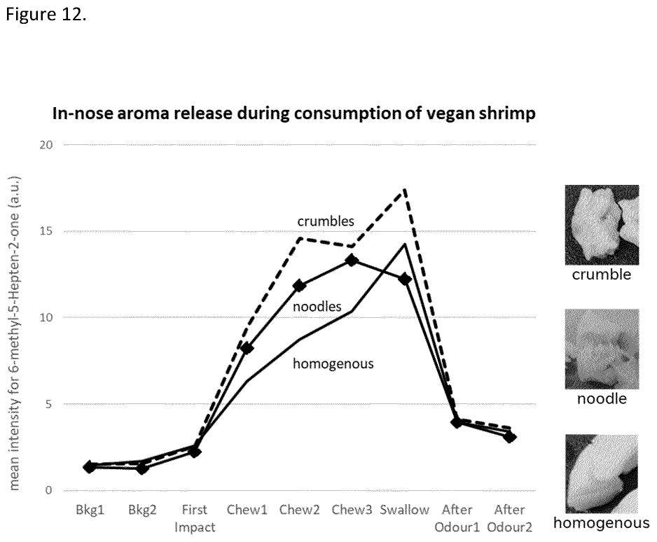

Spectrometer (PTR-MS) instrument. The individual signals (recorded as peak area) from each aroma compound during each food oral processing phase were then extracted and compared between samples (FIG. 12).

The aroma release pattern during consumption can be modulated with the internal structure of the vegan shrimps.
The aroma release was slower for homogenous gel structure compared to noodle- or crumble-like gel structures: it takes longer for the aroma compound to be released from the matrix. For the noodle- and crumble-like gel structures, the aroma release was significantly faster.
Though, the total aroma release during consumption was the same for all samples.
Behavior was compound-dependent: no differences were observed for dimethyl sulfide.

### Example 19

Recipe for Frozen-Thawed Shrimp with Reduced Konjac

| Ingredient | Content [%] |
|---|---|
| KGM | 1.10 |
| Pea fiber | 6.00 |
| Pea starch | 4.50 |
| NaCl | 0.90 |
| Sucrose | 0.80 |
| Sunflower oil | 5.00 |
| K₂CO₃ | 0.4 |
| Natural flavor | 0.5 |
| Water | 76.30 |
| SUM | 100 |

Pea inner cell wall fibre (moisture content 7.1 wt %) and water were weighed and mixed homogeneously whilst pouring in the weighted sunflower oil. This coarse pre-emulsion was mixed for 2 mins at room temperature. Pea starch, sucrose, NaCl, and natural flavour were weighed and mixed homogenously with the coarse pre-emulsion mix for at least 40 mins at room temperature.

The dough was filled into baking molds, sealed and heated to 90° C. for 20 min. The gel was cooled down by freezing for 1 hour, thawed and ground up with an extruder or slicer into small gel pieces (noodles), with average diameters over their shortest cross section of between 0.5 mm to 2 mm, and average length over their longest cross section of between 2 to 5 cm.

The gel pieces were mixed with the dough in the ratio of 1:1 to produce a mixture of dough and gel pieces. A few drops of plant-based orange colour (carrot & paprika concentrate) were added to a small portion of the dough (e.g. 50 g) to produce an orange dough which is then brushed on the inner surface of the shrimp mould. The mixture of dough and gel pieces was filled in the mould on top of the orange colour. The mould was sealed with vacuum before heating to 90° C. for 20 min with steam oven. The shrimp was then cooled down by freezing.

The vegan shrimp with homogenous texture and with fibrous structure is prepared following the same preparation process as described in example 5.

### Example 20

### Impact of Freeze-Thaw on Texture; 1.1% and 1.8% Recipes

### Recipe for 1.8% KGM Vegan Shrimp

| Ingredient | Content [%] |
|---|---|
| KGM | 1.8 |
| Pea fiber | 6.00 |
| Pea starch | 3.00 |
| NaCl | 1.14 |
| Sucrose | 0.80 |
| CaCO₃ | 0.5 |
| Na₂CO₃ | 0.4 |
| Natural flavor | 0.5 |
| Water | 81.30 |
| SUM | 100 |

Freeze-thawed shrimps were prepared following the same preparation process as described in Example 5. The impact of freezing and subsequent thawing of vegan shrimp had the similar texture and mouthfeel properties as described in Example 12.

| | | | | | Freeze- |
|---|---|---|---|---|---|
| Starch type | | | | Chilled vegan | thawed |
| Test | Parameter | [g/100 g] | Real shrimp | shrimp | vegan shrimp |
| CUT | Hardness | [N] | 10.54 ± 6.01 | 3.349 ± 0.599 | 3.284 ± 0.462 |
| | Deformation | [mm] | 6.23 ± 0.86 | 5.755 ± 1.043 | 6.092 ± 1.997 |
| | Gel strength | [N · mm] | 24.19 ± 8.17 | 8,466 ± 3.260 | 7.05 ± 1.84 |
| | Shear Energy | [N · mm] | 99.06 ± 10.82 | 23.1 ± 2.58 | 20.21 ± 1.44 |
| TPA | Firmness | [N] | 10.29 ± 2.09 | 4.545 ± 0.348 | 5.730 ± 0.948 |
| | Resilience | [%] | 67.68 ± 4.73 | 79.80 ± 3.42 | 79.58 ± 4.35 |
| | Cohesiveness | [%] | 85.76 ± 3.56 | 90.24 ± 1.82 | 89.91 ± 3.05 |
| | Gumminess | [N] | 8.84 ± 1.91 | 4.105 ± 0.332 | 5.134 ± 0.438 |

### Recipe for 1.1% KGM Vegan Shrimp

Freeze-thawed shrimps were prepared following Example 19. To get the similar texture and mouth feel as high KGM recipe (2.3%, Example 5), the starch content was increased, and vegan shrimps were subjected to freezing post-production.

| | | | | Freeze-thawed | |
|---|---|---|---|---|---|
| | | | | | 4.5% pea |
| Starch type | | | | 4.5% pea | starch & 2% |
| Test | Parameter | [g/100 g] | Real shrimp | starch | tapioca starch |
| CUT | Hardness | [N] | 10.54 ± 6.01 | 6.380 ± 0.997 | 8.625 ± 1.099 |
| | Deformation | [mm] | 6.23 ± 0.86 | 7.741 ± 0.600 | 7.116 ± 0.549 |
| | Gel strength | [N · mm] | 24.19 ± 8.17 | 18.104 ± 3.436 | 22.959 ± 4.135 |
| | Shear Energy | [N · mm] | 99.06 ± 10.82 | 36.620 ± 3.252 | 53.622 ± 7.379 |
| TPA | Firmness | [N] | 10.29 ± 2.09 | 6.547 ± 0.890 | 9.253 ± 1.143 |
| | Resilience | [%] | 67.68 ± 4.73 | 58.019 ± 2.035 | 62.942 ± 3.338 |
| | Cohesiveness | [%] | 85.76 ± 3.56 | 80.384 ± 2.331 | 84.093 ± 2.925 |
| | Gumminess | [N] | 8.84 ± 1.91 | 5.263 ± 0.737 | 7.764 ± 0.836 |

### Example 21

### Impact of Different Starch Types and Concentration on Texture

### 1.8% KGM

| | | | | Chilled | | Freeze-thawed | |
|---|---|---|---|---|---|---|---|
| | | Starch type | | | | | |
| | | | Real | 3% pea | 3% | 3% pea | 3% |
| Test | Parameter | [g/100 g] | shrimp | starch | tapioca | starch | tapioca |
| CUT | Hardness | [N] | 10.54 ± 6.01 | 10.58 ± 1.19 | 5.17 ± 0.57 | 24.51 ± 2.95 | 11.85 ± 1.43 |
| | Deformation | [mm] | 6.23 ± 0.86 | 8.95 ± 0.55 | 7.41 ± 0.68 | 10.56 ± 0.57 | 8.81 ± 0.42 |
| | Gel strength | [N · mm] | 24.19 ± 8.17 | 28.08 ± 2.80 | 12.21 ± 1.99 | 85.17 ± 12.55 | 32.31 ± 3.46 |
| | Shear Energy | [N · mm] | 99.06 ± 10.82 | 51.63 ± 2.56 | 30.21 ± 1.89 | 124.38 ± 7.98 | 57.06 ± 2.94 |
| TPA | Firmness | [N] | 10.29 ± 2.09 | 4.74 ± 0.88 | 3.65 ± 1.01 | 10.30 ± 0.58 | 6.43 ± 1.77 |
| | Resilience | [%] | 67.68 ± 4.73 | 77.75 ± 5.01 | 75.56 ± 3.64 | 58.42 ± 4.81 | 58.09 ± 2.27 |
| | Cohesiveness | [%] | 85.76 ± 3.56 | 89.68 ± 3.95 | 88.54 ± 2.61 | 78.97 ± 2.96 | 79.88 ± 1.90 |
| | Gumminess | [N] | 8.84 ± 1.91 | 4.25 ± 0.79 | 3.23 ± 0.88 | 8.14 ± 0.58 | 5.13 ± 1.39 |

### 1.1% KGM

| | | | | Freeze-thawed | |
|---|---|---|---|---|---|
| | | | | | 4.5% pea |
| Starch type | | | | 4.5% pea | starch & 2% |
| Test | Parameter | [g/100 g] | Real shrimp | starch | tapioca starch |
| CUT | Hardness | [N] | 10.54 ± 6.01 | 6.380 ± 0.997 | 8.625 ± 1.099 |
| | Deformation | [mm] | 6.23 ± 0.86 | 7.741 ± 0.600 | 7.116 ± 0.549 |
| | Gel strength | [N · mm] | 24.19 ± 8.17 | 18.104 ± 3.436 | 22.959 ± 4.135 |
| | Shear Energy | [N · mm] | 99.06 ± 10.82 | 36.620 ± 3.252 | 53.622 ± 7.379 |
| TPA | Firmness | [N] | 10.29 ± 2.09 | 6.547 ± 0.890 | 9.253 ± 1.143 |
| | Resilience | [%] | 67.68 ± 4.73 | 58.019 ± 2.035 | 62.942 ± 3.338 |
| | Cohesiveness | [%] | 85.76 ± 3.56 | 80.384 ± 2.331 | 84.093 ± 2.925 |
| | Gumminess | [N] | 8.84 ± 1.91 | 5.263 ± 0.737 | 7.764 ± 0.836 |

Vegan shrimp with starch mixture was prepared following the same preparation process as described in example 5, including pea starch, waxy maize starch and tapioca starch into the list of ingredients to be mixed and hydrated at the beginning of the process.

Starches with different compositions and concentrations were tested to understand which type of starch may be applicable to support/module the vegan shrimp texture. Sensory test (e.g., mouthfeel, color, flavor) and texture analysis were carried out. Pea starch, waxy maize starch, and tapioca starch were tested.

In general, vegan shrimp with pea starch showed good texture in both sensory and instrumental analysis, providing whiteness and neutral taste. Pea starch is composed of high amounts of amylose (50-55% amylose) which were proposed to explain improved texture and mouthfeel.

Waxy maize and tapioca starch performed similarly to pea starch in providing the white colour, however, the texture and mouthfeel was not acceptable at the same content (3%). They are soft and crumble easily in mouth. This is linked to their composition. Waxy maize starch is mostly amylopectin (<1% amylose) and tapioca starch contained medium amylose content (15-20%).

Therefore, it was concluded that pea starch with white colour and neutral taste, because of high amylose would be suitable for texture improvement of vegan shrimp when low content of KGM is used.

### Recipe for 1.1% KGM, Pea+Tapioca Starch

| Ingredient | Content [%] |
|---|---|
| KGM | 1.10 |
| Pea fiber | 4 |
| Pea starch | 4.50 |
| Tapioca starch | 2 |
| NaCl | 0.90 |
| Sucrose | 0.80 |
| Sunflower oil | 5.00 |
| K₂CO₃ | 0.4 |
| Natural flavor | 0.5 |
| Water | 76.30 |
| SUM | 100 |

Recipe for 1.1% KGM, Pea starch

| Ingredient | Content [%] |
|---|---|
| KGM | 1.10 |
| Pea fiber | 6.00 |
| Pea starch | 4.50 |
| NaCl | 0.90 |
| Sucrose | 0.80 |
| Sunflower oil | 5.00 |
| K₂CO₃ | 0.4 |
| Natural flavor | 0.5 |
| Water | 76.30 |
| SUM | 100 |

### Example 22

### Use of Potassium Carbonate, Calcium Hydroxide, Potassium Hydroxide

Alkaline solution was utilized to initiate KGM gelation for vegan shrimp preparation. Various concentrations were texted (0.3-0.5%) to give similar vegan shrimp texture mouthfeel as described in Example 5.

### Example 23

### Oil Addition to Replace Calcium Carbonate to Improve Whiteness

Freeze-thawed shrimps were prepared following Example 19 and Example 20. Replacing calcium carbonate with sunflower oil provided similar whiteness to vegan shrimp described in Example 5. The texture with sunflower oil addition provided a bit softer texture than with calcium carbonate but the difference was acceptable by sensory analysis as identified in Example 9. Any neutral oil can be used for calcium carbonate replacement.

| | | | | Freeze-thawed | |
|---|---|---|---|---|---|
| Starch type | | | | | 5% sunflower |
| Test | Parameter | [g/100 g] | Real shrimp | 0.5% CaCO₃ | oil |
| CUT | Hardness | [N] | 10.54 ± 6.01 | 5.751 ± 0.416 | 4.848 ± 0.778 |
| | Deformation | [mm] | 6.23 ± 0.86 | 8.205 ± 0.787 | 6.936 ± 0.746 |
| | Gel strength | [N · mm] | 24.19 ± 8.17 | 18.576 ± 3.336 | 13.761 ± 2.805 |
| | Shear Energy | [N · mm] | 99.06 ± 10.82 | 39.117 ± 1.923 | 32.387 ± 3.254 |
| TPA | Firmness | [N] | 10.29 ± 2.09 | 5.474 ± 1.193 | 6.723 ± 1.104 |
| | Resilience | [%] | 67.68 ± 4.73 | 49.415 ± 1.757 | 53.610 ± 2.896 |
| | Cohesiveness | [%] | 85.76 ± 3.56 | 85.028 ± 2.351 | 78.719 ± 1.362 |
| | Gumminess | [N] | 8.84 ± 1.91 | 4,632 ± 0.897 | 5.289 ± 0.853 |

1. A method of making a seafood analogue, said method comprising
a. Preparing a dough by
i. mixing konjac glucomannan, cell wall fiber, and seaweed, in water, wherein the seaweed is whole seaweed or seaweed water extract;
ii. Adjusting the pH of the dough by adding alkaline solution while mixing;
b. Preparing gel pieces by
i. Dividing the dough from step a) into portions and heating one portion to a temperature of between 80° C. to 100° C. to form a gel; or preparing a dough according to step a) and heating it to a temperature of between 80° C. to 100° C. to form a gel;
ii. Cooling the gel and mechanically disrupting to form gel pieces;
c. Mixing the gel pieces with the dough prepared in step a) or a portion of dough from step b i.) to produce a mixture;
d. Shaping the mixture from step c); and
e. Heating.

2. The method according to claim 1, wherein the cell wall fiber is a pea inner cell wall fiber.

3. The method according to claim 1, wherein the cell wall fiber is present at a concentration of about 6 wt % in the dough.

4. The method according to claim 1, wherein 3 to 10 wt % of a protein source.

5. The method according to claim 1, wherein between 3 to 6 wt % pea starch and between 2 to 5 wt % tapioca starch is mixed in step a).

6. The method according to claim 1, wherein mixing in steps a i. and ii.) occurs until at least a constant viscosity is achieved.

7. The method according to claim 1, wherein the pH is adjusted to 9.5 or above by the addition of alkaline solution.

8. The method according to claim 1, wherein the dough in step b i) is heated to form a gel at a temperature of about 90° C.

9. The method according to claim 1, wherein the gel pieces have an average diameter over their shortest cross section of between 0.1 mm to 5 mm, and an average length over their longest cross-section of between 0.5 cm to 5 cm.

10. The method according to claim 1, wherein the gel pieces are frozen and thawed to release water, preferably between 10-60% water is released, before mixing with the dough.

11. The method according to claim 1, wherein the gel pieces are mixed with the dough in a weight ratio of between 0.5:1 to 2:1 to produce a mixture.

12. The method according to claim 11, wherein the weight ratio is between 0.8:1 to 1.3:1.

13. The method according to claim 1, wherein the seafood analogue is frozen and then thawed.

14. (canceled)

15. A seafood analogue comprising konjac glucomannan and cell wall fiber, wherein said fiber is pea cell wall fiber, and wherein said seafood analogue comprises gel pieces bound in a continuous matrix.

16-17. (canceled)
